(19) United States
(12) Patent Application Publication
(10) Pub. No.: US 2026/0158677 A1
(43) Pub. Date: Jun. 11, 2026

(54) VARIABLE WIRE GRIPPER AND GRIPPER SYSTEM

(71) Applicant: KOREA INSTITUTE OF SCIENCE AND TECHNOLOGY, Seoul (KR)

(72) Inventors: Kahye SONG, Seoul (KR); Min Soo KIM, Seoul (KR); Jun Pil CHOE, Seoul (KR); Jun Hyung PARK, Seoul (KR)

(73) Assignee: KOREA INSTITUTE OF SCIENCE AND TECHNOLOGY, Seoul (KR)

(21) Appl. No.: 19/181,087

(22) Filed: Apr. 16, 2025

(30) Foreign Application Priority Data
Jul. 2, 2024 (KR) 10-2024-0086544

(51) Int. Cl. B25J 15/00

(52) U.S. Cl. CPC B25J 15/0038

(57) ABSTRACT

The present invention relates to a gripper. The variable wire gripper includes a plurality of wires, each having a loop formed by a curved middle portion and positioned forward, with one end fixed to a rotating body and the other end fixed to a linear moving part, and has a technical feature of surrounding and gripping an object while the loops of the wires positioned forward converge on each other due to rotation of the rotating body and linear movement of the linear moving part, and releasing the grip on the object while spreading apart from each other. A variable wire gripper system includes the variable wire gripper and a motor connected to the rotating body to rotate the rotating body, and has a technical feature in that the linear moving part is mounted on the rotating body and moves linearly in engagement with the rotation of the rotating body.

### CROSS REFERENCE TO RELATED APPLICATION

The present application claims priority to Korean Patent Application No. 10-2024-0086544, filed Jul. 2, 2024, the entire contents of which are hereby incorporated by this reference.

### BACKGROUND OF THE INVENTION

### Field of the Invention

The present invention relates to a gripper that is mounted at the end of a transport means and is capable of gripping an object to transport the object, and a gripper system thereof, configured to be soft to prevent damage to the object so as to prevent damage to the object while being capable of stably lifting heavy objects, and also designed to be capable of gripping the object even in narrow spaces.

The present invention was conducted with the support of the National Research and Development Project of the Republic of Korea (Project Numbers: 2E33000).

### NATIONAL RESEARCH AND DEVELOPMENT PROJECT FOR SUPPORTING INVENTION

Project Unique No.: 2710034016
Subject No.: 2E33000
Department Name: Ministry of Science and ICT
Research and Management Institution: Korea Institute of Science and Technology (KIST)
Project Name: KIST Research Operation Fund Support (Major Project Fund)
Subject Name: Development of Coexistent Intelligent Metabot Technology
Host Institution: Korea Institute of Science and Technology (KIST)
Research Period: Jan. 1, 2024-Dec. 31, 2024

### Description of the Related Art

To move an object to a different position, a gripper that grips the object and a transport means capable of lifting the object from its current position and transporting the object to the destination are typically required.

The transport means may typically include a robotic arm, conveyor, or a telescoping hydraulic system with a stroke. The object is gripped by the gripper, and the transport means is operated to lift the object, move it to the desired position, and then place the object at the destination.

In the drawings, FIG. 1 is a conceptual view illustrating a gripper mounted at the end of a robotic arm according to the related art, and FIG. 2 is a conceptual view illustrating the relationship of pressing and lifting an object through the gripper illustrated in FIG. 1.

As illustrated in FIG. 1, a robotic arm 1 is designed with a multi-joint structure, allowing an object 5 to be moved within the available range of the robotic arm 1.

At the end of the robotic arm 1, a gripper 3 is mounted, and the gripper 3 grips the object 5 by pressing against the side of the object 5.

In this case, a force applied by the gripper 3 to the side of the object 5 (hereinafter referred to as “grip force”) needs to be greater than the weight of the object 5. This is to prevent the object 5 from slipping and falling off the gripper 3 when the object 5 is moved by the operation of the robotic arm 1.

Therefore, an appropriate gripper needs to be selected and mounted on the robotic arm depending on the weight or shape of the object. However, when the objects are irregularly shaped and have different weights, it becomes difficult to select and replace an appropriate gripper each time for mounting on the robotic arm.

In addition, to generate a large grip force, the capacity of the actuator needs to also increase proportionally, in which case it is common for the weight and volume of the actuator to also increase. When the weight and volume of the actuator increase, the payload also increases in mounting the gripper on the transport means such as the robotic arm or conveyor, causing the issue that the capacity of the transport means needs to also increase proportionally.

Additionally, as illustrated in FIG. 2, the gripper 3 is illustrated as gripping the object 5 with a structure where the side of the object 5 is vertical. However, when the shape of the object 5 is concave or convex, the contact points of a left gripper 3L and a right gripper 3R with the object 5 become unstable. During the process of lifting the object 5, the center of gravity of the object 5 shifts, leading to the disadvantage of potentially dropping the object 5.

In order to transport various types and shapes of objects, it is necessary to have a variety of grippers available, and there is an inefficient issue of having to frequently replace the gripper depending on the object.

In addition to these issues, as illustrated in FIG. 2, the left gripper 3L and the right gripper 3R move in opposite directions to open (dashed line position in FIG. 2), and then move toward each other to press against the side of the object, thereby gripping the object 5 (solid line position in FIG. 2). In other words, to grip the object 5 with the conventional gripper 3, the left gripper 3L and the right gripper 3R need to go through the process of opening to a width wider than the width of the object 5.

As the operating range of the gripper 3 to grip the object 5 operates relatively widely compared to the width of the object 5, a problem arises in that it becomes impossible to grip the object 5 positioned in narrow spaces.

In addition, although not illustrated in the drawings, in case of a gripper that uses a suction pad to suction and transport the object, the suction pad needs to be regularly maintained to ensure a suction force with the object. Additionally, components such as a vacuum pump or compressor, which are necessary to maintain the inner side of the suction pad in a vacuum state, need to be provided as separate essential components outside the robotic arm. Further, a gripper with a suction pad is only applicable to light objects, and for it to be applied to heavy objects, a large gripper with multiple suction pads needs to be provided. This results in the problem of an increased capacity requirement for the transport means.

Meanwhile, FIG. 3 is a conceptual view illustrating a spiral loop-type gripper according to the related art, and FIGS. 4A and 4B are conceptual views illustrating the operational relationship of the gripper illustrated in FIG. 3.

The gripper illustrated in FIG. 3, FIG. 4A, and FIG. 4B is based on the invention disclosed in Korean Patent No. 10-2555319. A spiral loop-type gripper 10 includes an upper plate 11, a lower plate 12 that rotates relative to the upper plate 11, and a plurality of spiral loops 13, each of whose ends is connected to or extends from the upper plate 11 and the lower plate 12, with twisted midway through their length. As the upper plate 11 and lower plate 12 rotate relative to each other, the middle portion of the length of the spiral loop 13 converges or diverges.

When the upper plate 11 and lower plate 12 rotate relative to each other, the plurality of spiral loops 13 spread apart, and the object is placed inside the opened spiral loops 13. Then, when the upper plate 11 and lower plate 12 rotate in reverse relative to each other, the spiral loops 13 converge, entering between the ground and the object to surround and grip the object, creating the operational relationship.

The spiral loop-type gripper 10 according to the related art grips the object by supporting the bottom of the object after the spiral loop 13 enters between the ground and the bottom of the object. Therefore, it is preferable for the spiral loop 13 to have a thin thickness.

However, in order for the spiral loop 13 to lift and transport the object, a tension proportional to the weight of the object is required. To satisfy this, the width of the spiral loop 13 is configured to be wide relative to its thin thickness. As the width of the spiral loop 13 widens, as described above, the operating range of the gripper 10 also widens, which in turn leads to problems such as interference with surrounding objects in narrow spaces.

### DOCUMENTS OF RELATED ART

### Patent Document

(Patent Document 1) WO 2016-172670 A1 (Oct. 27, 2016)
(Patent Document 2) U.S. Pat. No. 9,464,642 B2 (Oct. 11, 2016)
(Patent Document 3) Korean Patent No. 10-2555319 (Jul. 14, 2023)

### Non-Patent Document

(Non-Patent Document 1)A Vacuum-driven Origami “Magic-ball” Soft Gripper, Li et al. (2019).
(Non-Patent Document 2)Buckling of Elastomeric Beams Enables Actuation of Soft Machines, Yang et al. (2015).

### SUMMARY OF THE INVENTION

The present invention has been made in an effort to solve the problems of the related art described above, and an object of the present invention is to provide a variable wire gripper and gripper system that are configured to minimize the operational range of a wire loop by rotating one end of the wire and linearly moving the other end of the wire to converge or spread the wire loop formed forward, thereby enabling the gripping of objects in narrow spaces.

To achieve the aforementioned object, there is provided a variable wire gripper, according to the present invention. The variable wire gripper includes a plurality of wires, each having a loop formed by a curved middle portion and positioned forward, with one end fixed to a rotating body and the other end fixed to a linear moving part, in which the loops of the wires positioned forward converge on each other due to rotation of the rotating body and linear movement of the linear moving part, to surround and grip an object, or spread apart from each other to release the grip on the object.

In addition, according to a preferred embodiment of the present invention, the rotating body and the linear moving part are engaged by a single motor.

In addition, according to a preferred embodiment of the present invention, the rotating body is a ball screw, the linear moving part is a toggle nut, and when the ball screw rotates due to the motor, the toggle nut mounted on the ball screw moves linearly, or when the toggle nut is moved linearly by the motor, the ball screw rotates due to the movement of the toggle nut.

In addition, according to a preferred embodiment of the present invention, a support body capable of rotating freely along a circumference is mounted around a tip of an end of the ball screw, and the wire forming a loop in front of the tip passes through the support body and extends to the linear moving part.

In addition, according to a preferred embodiment of the present invention, a hole is formed at an edge of an end surface of the tip of the ball screw, into which one end of the wire is inserted and fixed, and the wire forming a loop in front of the tip passes through a through hole formed in the support body, extending linearly to the toggle nut, with the other end of the wire fixed to the toggle nut.

In addition, according to a preferred embodiment of the present invention, a collar is formed on one of a circumference of the tip of the ball screw or an inner circumferential surface of the support body, and a groove is formed on the other to engage the collar, with the engagement of the collar and the groove allowing the support body to rotate freely around the circumference of the tip.

In addition, according to a preferred embodiment of the present invention, the hole formed in the tip of the ball screw has an inclined structure, sloping from a center of the tip to the edge as the hole approaches the end surface of the tip.

In addition, according to a preferred embodiment of the present invention, ends of the wires inserted into the hole are mutually bundled and fixed within the ball screw.

In addition, according to a preferred embodiment of the present invention, the toggle nut is fixed to a nut plate, the nut plate has a plurality of guide bars fixed thereto, and the plurality of guide bars pass through the base plate to guide the linear movement of the toggle nut.

In addition, according to a preferred embodiment of the present invention, the ball screw passes through the nut plate and is rotatably mounted on the base plate.

To achieve the aforementioned object, there is provided a variable wire gripper system, according to the present invention. The variable wire gripper system includes: a variable wire gripper having a plurality of wires, each having a loop formed by a curved middle portion and positioned forward, with one end fixed to a rotating body and the other end fixed to a linear moving part, and configured to surround and grip an object while the loops of the wires positioned forward converge on each other due to rotation of the rotating body and linear movement of the linear moving part, and release the grip on the object while spreading apart from each other; and a motor connected to the rotating body to rotate the rotating body, in which the linear moving part is mounted on the rotating body and moves linearly in engagement with the rotation of the rotating body.

In addition, according to a preferred embodiment of the present invention, the linear moving part is mounted with a plurality of guide bars, and the plurality of guide bars pass through a base plate to guide the linear movement of the linear moving part, and the motor mounted on the base plate is connected to the rotating body mounted rotatably on the base plate to rotate the rotating body.

In addition, according to a preferred embodiment of the present invention, the rotating body is a ball screw, and the linear moving part is a toggle nut.

To achieve the aforementioned object, there is provided a variable wire gripper system, according to the present invention. The variable wire gripper system includes: a variable wire gripper having a plurality of wires, each having a loop formed by a curved middle portion and positioned forward, with one end fixed to a rotating body and the other end fixed to a linear moving part, and configured to surround and grip an object while the loops of the wires positioned forward converge on each other due to rotation of the rotating body and linear movement of the linear moving part, and release the grip on the object while spreading apart from each other; and a linear motor connected to the linear moving part to move the linear moving part in forward and backward directions, in which the linear moving part is mounted on the rotating body, and the rotating body rotates in engagement with the movement of the linear moving part.

In addition, according to a preferred embodiment of the present invention, the linear moving part is mounted with a plurality of guide bars, and the plurality of guide bars pass through a base plate to guide the linear movement of the linear moving part, and the linear motor mounted on the base plate is connected to the guide bars to move the guide bars in forward and backward directions.

In addition, according to a preferred embodiment of the present invention, the rotating body is a ball screw, and the linear moving part is a toggle nut.

As described above, the variable wire gripper according to the present invention can converge or spread the wire loop toward or away from the center of the rotating body by the rotation of the rotating body, while simultaneously adjusting the curvature radius of the wire loop through the movement of the linear moving part, thereby gripping the object by surrounding it with a plurality of fine wires. In particular, as the loops of the wires surround and grip an object in a hemispherical woven structure, like a woven basket, from the front of the tip, it is possible to grip even small ball-shaped objects, and it has the advantage of being able to grip and release objects in narrow spaces.

Therefore, the variable wire gripper and gripper system according to the present invention have the advantage of reducing the payload by using the wires made of a thin, soft, high tension material to grip and then transport an object while being lightweight.

Further, the gripper system according to the present invention may be configured to operate by rotating the rotating body or to operate by moving the linear moving part in configuring the rotating body and the linear moving part to be engaged. Therefore, there is the advantage of being able to selectively apply various types of power sources.

### BRIEF DESCRIPTION OF THE DRAWINGS

FIG. 1 is a conceptual view illustrating a gripper mounted at the end of a robotic arm according to the related art.

FIG. 2 is a conceptual view illustrating the relationship of pressing and lifting an object through the gripper illustrated in FIG. 1.

FIG. 3 is a conceptual view illustrating a spiral loop-type gripper according to the related art.

FIGS. 4A and 4B are conceptual views illustrating the operational relationship of the gripper illustrated in FIG. 3.

FIG. 5 is a perspective view illustrating a variable wire gripper according to an embodiment of the present invention.

FIG. 6 is a longitudinal sectional view of the variable wire gripper illustrated in FIG. 5.

FIG. 7 is a conceptual view illustrating the coupling relationship between a tip of a ball screw, a support body, and a wire illustrated in FIG. 5.

FIGS. 8A and 8B are conceptual views illustrating the deformation state of a wire loop due to the rotation of the ball screw.

FIG. 9 is a conceptual view illustrating an example where a linear wire extended from the support body to a toggle nut is twisted when the support body rotates due to the rotation of the ball screw.

FIGS. 10A to 10C are conceptual views illustrating the operational relationship of a gripper system according to an embodiment of the present invention.

FIGS. 11A to 11C are conceptual views illustrating the operational relationship of a gripper system according to another embodiment of the present invention.

FIGS. 12A to 12D are conceptual views illustrating the relationship of gripping a spherical object using the wire of the gripper.

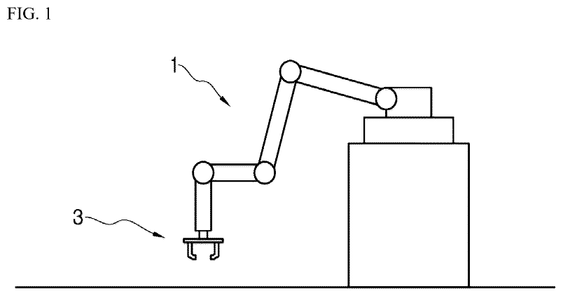

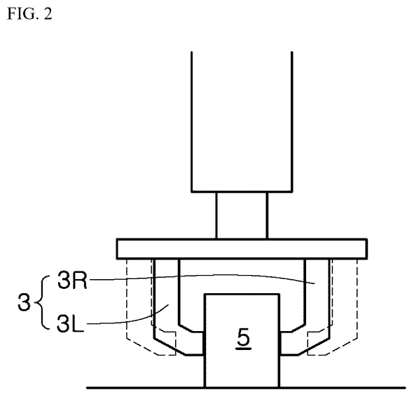

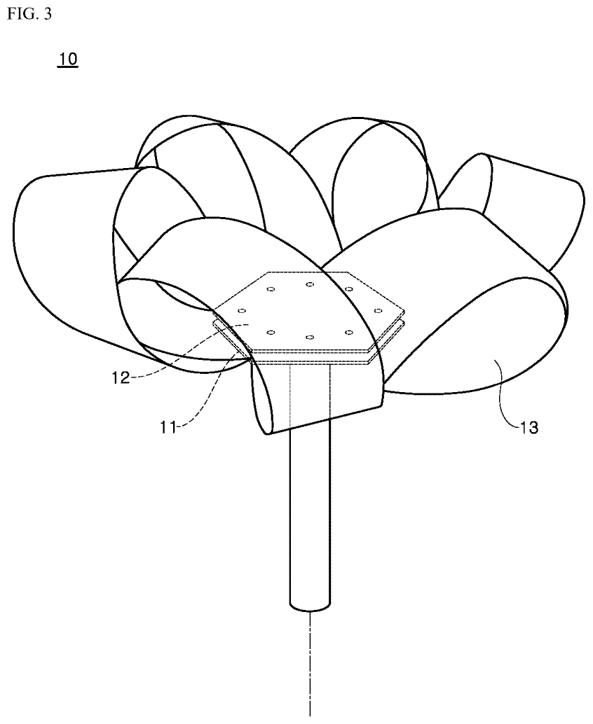

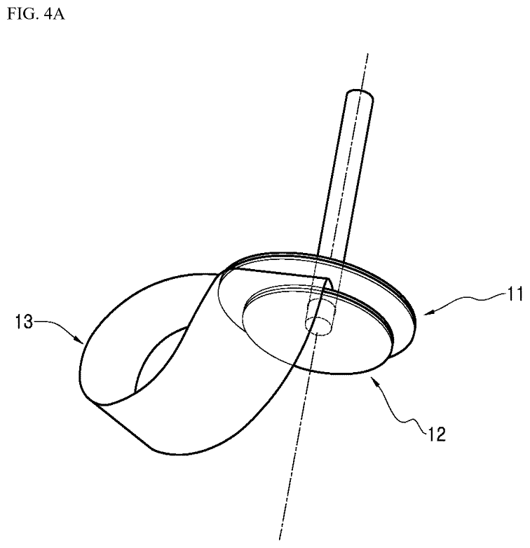

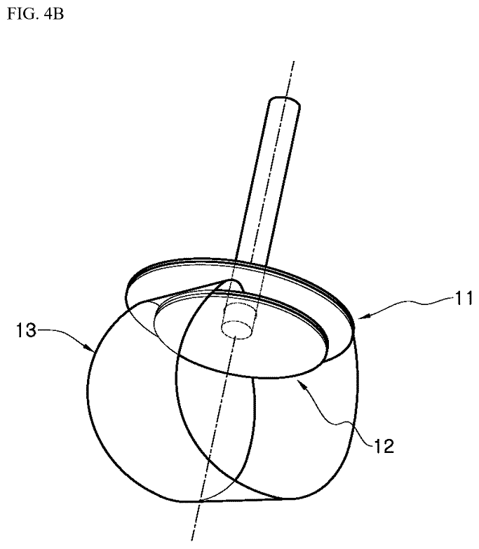

### DETAILED DESCRIPTION OF THE INVENTION

Below, the preferred embodiments of the variable wire gripper and gripper system according to the present invention will be described in detail with reference to the attached drawings.

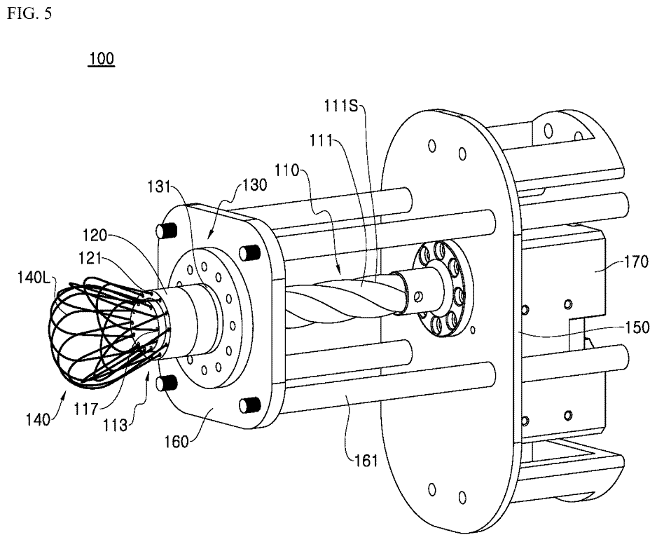

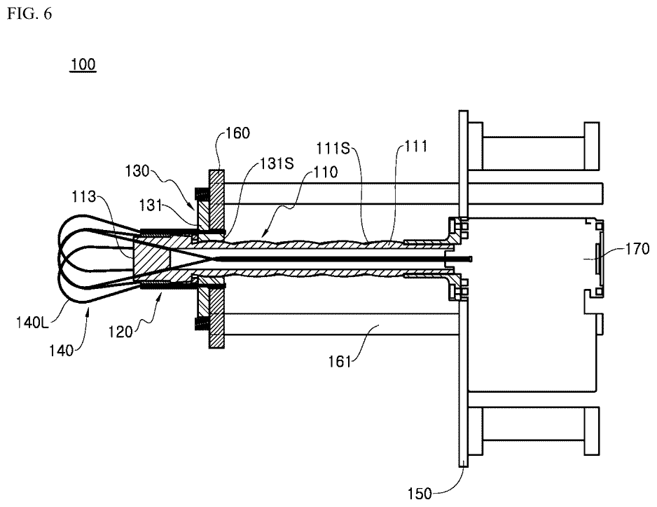

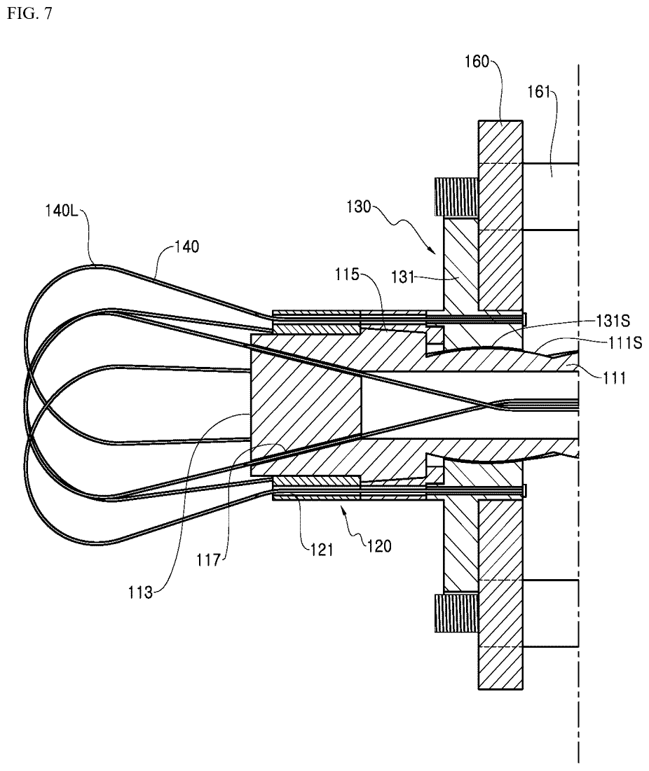

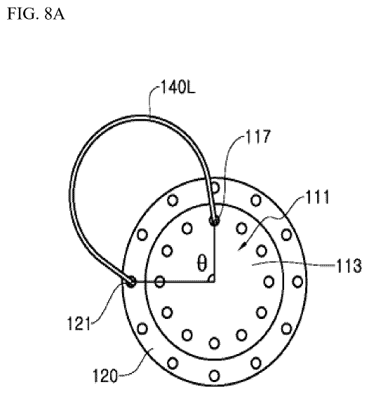

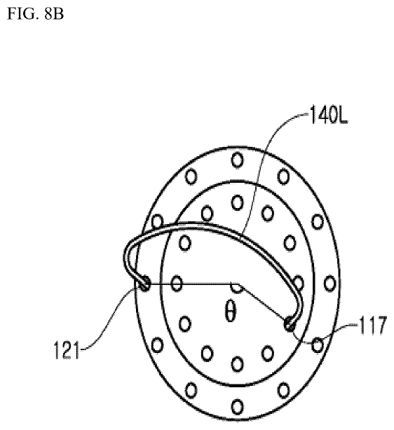

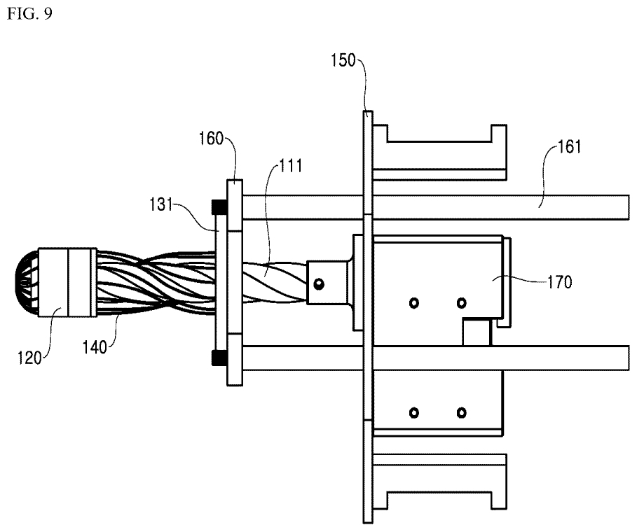

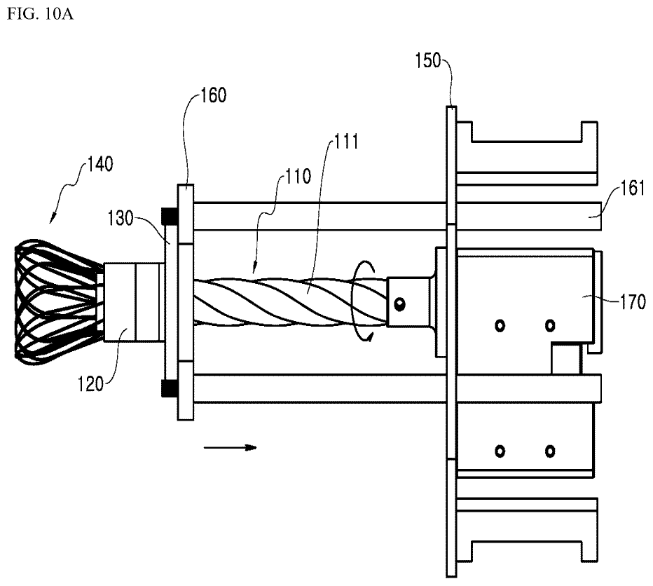

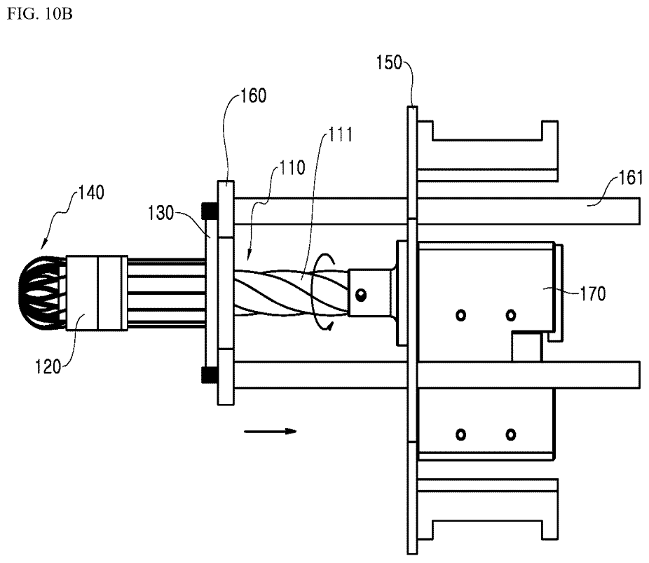

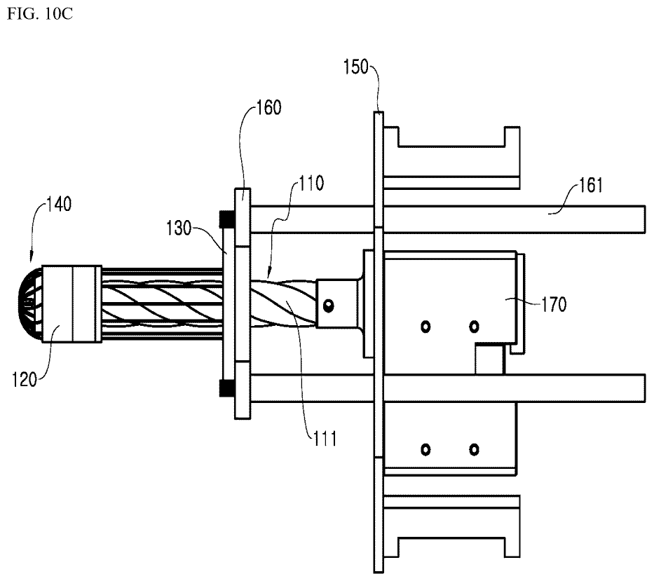

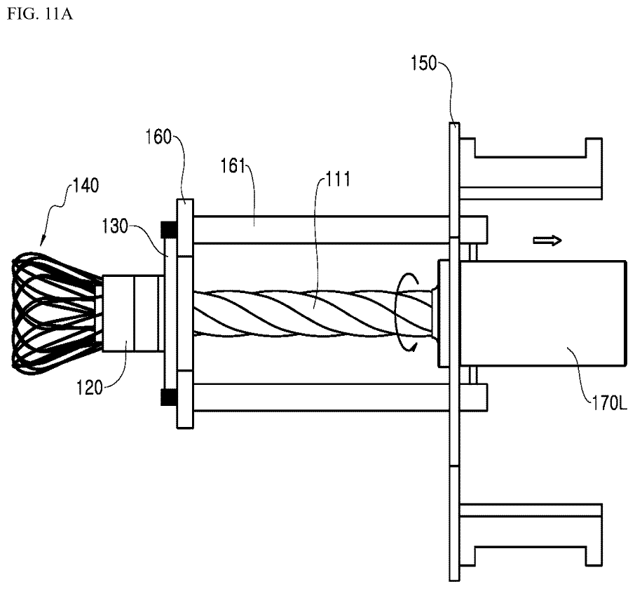

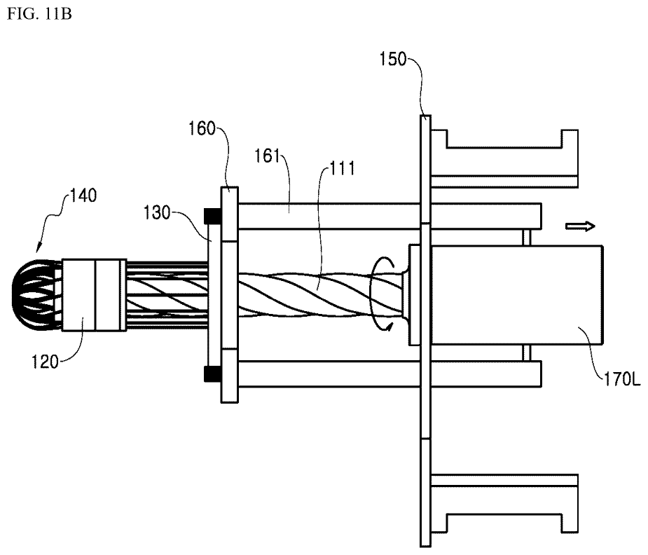

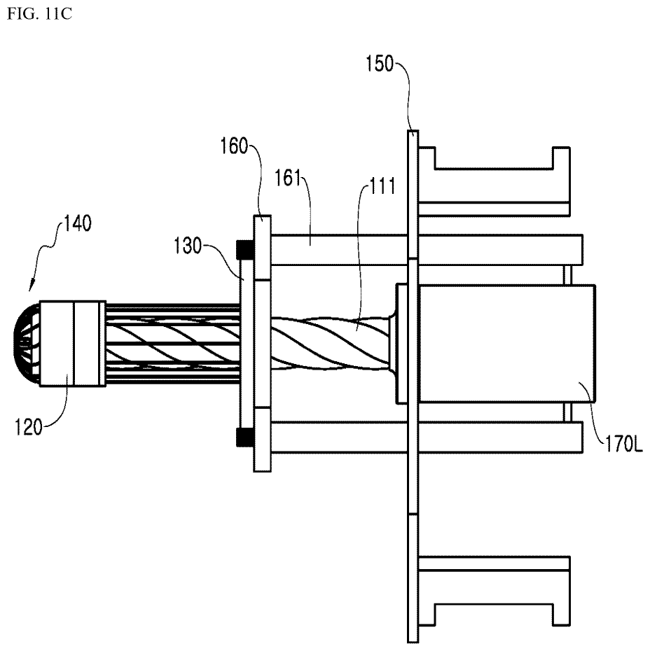

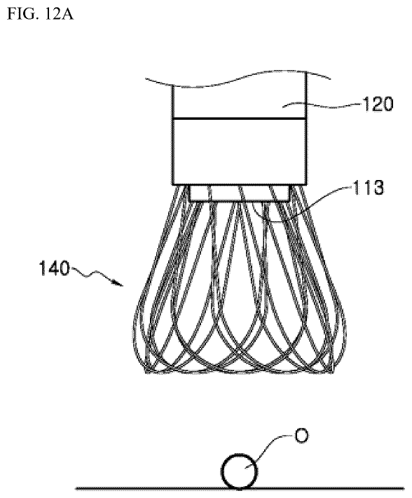

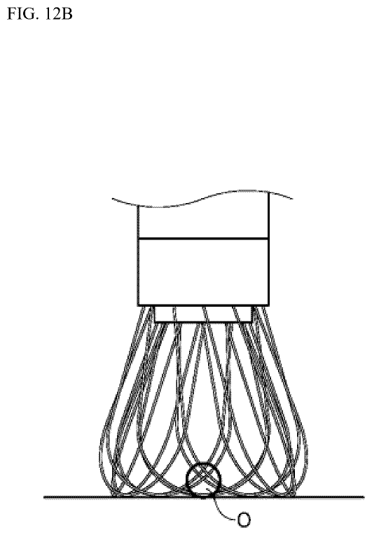

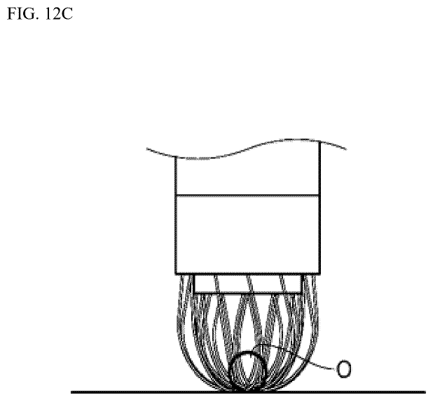

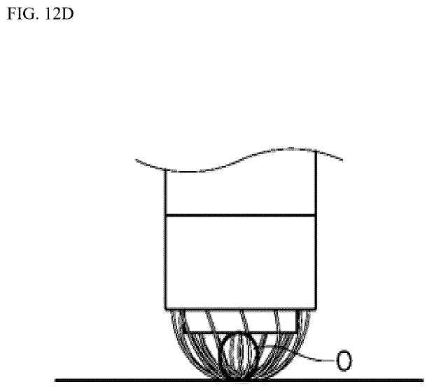

In the drawings, FIG. 5 is a perspective view illustrating a variable wire gripper according to an embodiment of the present invention, FIG. 6 is a longitudinal sectional view of the variable wire gripper illustrated in FIG. 5, FIG. 7 is a conceptual view illustrating the coupling relationship between a tip of a ball screw, a support body, and a wire illustrated in FIG. 5, and FIGS. 8A and 8B are conceptual views illustrating the deformation state of a wire loop due to the rotation of the ball screw. Further, FIG. 9 is a conceptual view illustrating an example where a linear wire extended from the support body to a toggle nut is twisted when the support body rotates due to the rotation of the ball screw, FIGS. 10A to 10C are conceptual views illustrating the operational relationship of a gripper system according to an embodiment of the present invention, and FIGS. 11A to 11C are conceptual views illustrating the operational relationship of a gripper system according to another embodiment of the present invention. In addition, FIGS. 12A to 12D are conceptual views illustrating the relationship of gripping a spherical object using the wire of the gripper.

As illustrated in FIGS. 5 and 6, a variable wire gripper 100 includes a rotating body 110 rotated by a power source, a linear moving part 130 mounted on the rotating body 110 and moving linearly due to the rotation of the rotating body 110, and a plurality of wires 140, one end of which is fixed to the rotating body 110 and the other end is fixed to the linear moving part 130, forming a loop 140L at the front of the rotating body 110. By the rotation of the rotating body 110 and the linear movement of the linear moving part 130, a loop 140L of the wire converges toward the center of the rotating body 110, while the size of the loop 140L decreases, thereby wrapping and gripping an object O positioned in front of the rotating body 110 with the loops 140L of the wires 140. Conversely, as the size of the loops 140L of the wires 140 increases and simultaneously spreads outward, the gripping of the object O is released.

Hereinafter, the variable wire gripper 100, configured as described above, will be explained in more detail.

As illustrated in FIGS. 5 and 6, the rotating body 110 is a ball screw 111 with a helical thread 111S formed along the length direction, and the linear moving part 130 mounted on the circumference of the ball screw 111 is composed of a toggle nut 131. On the inner circumferential surface of the toggle nut 131, a helical thread 131S corresponding to the helical thread 111S of the ball screw 111 is formed, thereby maintaining a threaded engagement with the ball screw 111. Therefore, the rotation of the ball screw 111 causes the toggle nut 131 to move linearly along the length direction of the ball screw 111. Conversely, the linear movement of the toggle nut 131 also enables the rotation of the ball screw 111.

As illustrated in FIGS. 10A to 10C, when the ball screw 111 rotates, the toggle nut 131 moves linearly along the length direction of the ball screw 111. As another example of the variable wire gripper 100, as illustrated in FIGS. 11A to 11C, the toggle nut 131 may be configured to move linearly while causing the ball screw 111 to rotate.

In the variable wire gripper 100 as described, the ball screw 111 passes through a base plate 150, and a motor 170, which serves as the power source, is mounted on the outer surface of the base plate 150. The shaft of the motor 170 is connected to the ball screw 111, which passes through the base plate 150. Therefore, when the motor 170 operates, the ball screw 111 rotates, and the toggle nut 131 moves linearly along the length of the ball screw 111.

A support body 120 of a bearing structure is mounted around a tip 113 at the end of the ball screw 111, which allows free rotation along the circumference of the tip 113.

As illustrated in FIG. 7, around the tip 113 of the ball screw 111, a collar 115 with a diameter greater than the tip 113 is formed along the circumference of the tip 113. The support body 120 has a groove on its inner circumferential surface that engages the collar 115, and by the engagement of the collar 115 and the groove, the support body 120 is rotatably mounted around the circumference of the tip 113 while surrounding the collar 115. The support body 120 may only rotate along the circumference of the tip 113 and does not move in the length direction of the ball screw 111 due to the engagement between the collar 115 and the groove.

In the coupling structure between the tip 113 of the ball screw 111 and the support body 120, as described, although not illustrated in the drawings, a bearing may be mounted between the inner circumferential surface of the support body 120 and the outer circumferential surface of the circumference of the tip 113 to facilitate smoother rotation of the support body 120.

Meanwhile, the support body 120 has a plurality of through holes 121, which connect one end surface and the other end surface, formed at equal intervals along the circumference of the support body 120. The tip 113 of the ball screw 111 has a plurality of holes 117 on an end surface, which are formed at equal angles along the edge of the end surface of the tip 113.

Here, the number of through holes 121 formed in the support body 120 and the number of holes 117 formed along the edge of the end surface of the tip 113 are the same as the number of wires 140. One end of the wire 140 is inserted into the hole 117 formed on the end surface of the tip 113, where the ends of the wires are mutually bundled and fixed inside the ball screw 111. The other end of the wire 140 passes through the through hole 121 of the support body 120 and is then fixed to the toggle nut 131, extending to the toggle nut 131.

In this case, as illustrated in FIGS. 8A and 8B, an angle θ between the through hole 121 of the support body 120, which a single wire 140 passes through, and the hole 117 of the tip 113 changes as the ball screw 111 rotates in a clockwise or counterclockwise direction due to the motor 170.

Examining the form of the wire 140 configured as described, one end of the wire 140 is drawn out from the hole 117 formed along the edge of the end surface of the tip 113 of the ball screw 111, extends in front of the tip 113, then curves backward and is inserted into the through hole 121 of the support body 120. As a result, the middle portion of the wire 140 forms the loop 140L according to the angle θ between the hole 117 and the through hole 121. When the angle θ between the hole 117 and the through hole 121 is large, the loop 140L converges toward the center C of the end surface of the tip 113. Conversely, when the angle θ between the hole 117 and the through hole 121 is small, the loop 140L moves away from the center C of the end surface of the tip 113 and is positioned toward the edge.

The wire 140, which passes through the hole 117 of the support body 120, extends in a straight line, parallel to each other, to the toggle nut 131, where it is then fixed to the toggle nut 131.

The wire 140 that passes through the support body 120 forms the loop 140L at the front of the support body 120, while maintaining a linear extension toward the rear, all the way to the toggle nut 131. Therefore, even if the ball screw 111, which is the rotating body 110, rotates, the wires 140, which are parallel and extended linearly toward the rear, support the ball screw 111, preventing it from rotating along the tip 113 of the ball screw 111 and ensuring that it maintains its correct position. This may vary somewhat depending on the elasticity of the wire 140.

The gripper 100 according to the present invention is most preferably designed to keep the support body 120 in its correct position. However, as illustrated in FIG. 9, due to the elasticity of the wire 140 and the friction between the tip 113 and the support body 120, the support body 120 may rotate slightly in the direction of rotation of the rotating body 110. As a result, the wire 140, which extends linearly from the support body 120 to the toggle nut 131, may experience slight twisting due to the rotation of the ball screw 111. However, such variations do not significantly affect the structure and function of the gripper of the present invention.

Meanwhile, as illustrated in FIG. 7, the holes 117 formed in the tip 113 of the ball screw 111 are formed in a structure inclined from the center of the tip 113 to the edge as they approach the end surface of the tip 113. The ends of the wires 140 passing through the hole 117 is mutually bundled and fixed at the center inside the ball screw 111.

As the hole 117 has an inclined structure extending from the center of the tip 113 to the edge of the end surface of the tip 113, the loop 140L of the wire 140 extended to the front of the tip 113 has an outwardly spread shape at the edge of the tip 113. Nevertheless, since the support body 120 maintains its correct position around the circumference of the tip 113, and the wire 140 passes through the through hole 121 of the support body 120, the loop 140L formed at the front of the tip 113 does not significantly extend beyond the cross-sectional range of the support body 120.

In this way, the support body 120 limits the expansion of the loop 140L beyond the outer side of the tip 113, allowing the gripper 100 according to the present invention to smoothly grip and release the object in narrow spaces.

The gripper 100 configured in this way may grip the object within a range that does not significantly extend beyond the cross-sectional range of the support body 120, even if the rotating body 110 rotates and the toggle nut 131 moves linearly, causing the size of the wire loop 140L to increase or decrease.

Meanwhile, the toggle nut 131 is fixed to a nut plate 160, and at each corner of the rectangular-shaped nut plate 160, a guide bar 161 is fixed in the direction of the base plate 150. The ball screw 111 passes through the center of the nut plate 160. Further, the guide bar 161 passes through the base plate 150 and stably guides the linear movement direction of the toggle nut 131.

Hereinafter, embodiments of a gripper system with the motor 170 mounted on the variable wire gripper 100 will be described in detail.

As illustrated in FIGS. 10A to 10C, when the variable wire gripper 100 is configured such that the toggle nut 131 moves linearly in engagement with the rotation of the ball screw 111, the motor 170 is mounted on the base plate 150, and the shaft of the motor 170 is connected to the ball screw 111. The ball screw 111 rotates under the power of the motor 170, accordingly causing the toggle nut 131 to move linearly.

As another example of the gripper system, as illustrated in FIGS. 11A to 11C, when the pitch of the ball screw 111 is large, the ball screw 111 may be configured to rotate by the linear movement of the toggle nut 131. In this case, a linear motor 170L is mounted on the base plate 150 for the linear movement of the toggle nut 131, and the linear motor 170L is connected to the guide bar 161. Thus, under the power of the linear motor 170L, the toggle nut 131 is moved linearly, and the linear movement of the toggle nut 131 causes the ball screw 111 to rotate in engagement.

In this way, the variable wire gripper 100 according to the present invention may apply different power sources, such as motors 170 and 170L, depending on its configuration.

Hereinafter, the operational relationship of the variable wire gripper system, where the ball screw 111 rotates by the motor 170, will be explained in detail.

As illustrated in FIGS. 10A to 10C, when the motor 170 operates, the ball screw 111 rotates, and due to the rotation of the ball screw 111, one end of the wire 140 rotationally moves in the rotational direction of the ball screw 111. At the same time as the rotation of the ball screw 111, the toggle nut 131 moves backward in the direction in which the base plate 150 is positioned, and as the toggle nut 131 moves backward, the other end of the wire 140 also moves backward. Eventually, the curvature radius of the wire loop 140L decreases, causing the loop to converge toward the center of the ball screw 111.

Here, the support body 120 maintains its correct position regardless of the rotation of the ball screw 111 by the wires 140 that extend linearly and parallel from the toggle nut 131. Therefore, the middle portion of length of the wire 140 is supported in its correct position by the support body 120. As one end of the wire 140 rotates due to the rotation of the ball screw 111, and at the same time, the toggle nut 131 moves backward, the curvature radius of the wire loop 140L decreases, causing the loop to converge toward the center of the ball screw 111.

In this state, when the ball screw 111 rotates in reverse due to the operation of the motor 170, the toggle nut 131 moves forward. As a result, the curvature radius of the wire loop 140L increases, causing the loop to spread outward from the center of the ball screw 111.

Accordingly, as illustrated in FIGS. 12A to 12D, before the wire loops 140L positioned at the front of the tip 113 converge, the object O is positioned inside the wire loops 140L. Then, by operating the motor 170 to cause the wire loops 140L to converge, the wire loops 140L have a woven structure, surrounding the object O at the front of the tip 113. As a result, the object O is positioned inside the hemispherical, i.e., woven basket-like, wire loop 140L. Even spherical objects, such as a ball, may be gripped by being contained inside the woven basket-like wire loop 140L.

Conversely, when the ball screw 111 is rotated in reverse while gripping the object O, the toggle nut 131 moves forward, causing the curvature radius of the wire loops 140L to increase. At the same time, the loops spread outward from the center of the ball screw 111, thereby releasing the object O from the grip.

Meanwhile, in another embodiment of the variable wire gripper system mounted with a linear motor 170L (see FIGS. 11A to 11C), when the linear motor 170L operates, the toggle nut 131 moves backward. As the toggle nut 131 moves backward, the ball screw 111 rotates, and due to the rotation of the ball screw 111, one end of the wire 140 moves in the rotational direction of the ball screw 111. As described above, with the backward movement of the toggle nut 131, the ball screw 111 rotates, causing the curvature radius of the wire loop 140L to decrease, and the wire loop 140L converges toward the center of the ball screw 111. As the wire loops 140L have a woven hemispherical shape, they surround and grip the object O inside.

In this state, when the linear motor 170L operates and the toggle nut 131 moves forward, the curvature radius of the wire loop 140L increases accordingly, causing the loops to spread outward from the center of the ball screw 111. When the woven hemispherical wire loops 140L spread outward, the object that was gripped inside the loops moves outward from the wire loops 140L, releasing the grip.

The base plate 150 of the gripper system, configured as described, may be mounted on transport means such as a robotic arm, conveyor, or a telescoping hydraulic system with a stroke, allowing the object gripped by the gripper 100 to be moved to a set point.

The variable wire gripper 100 of the present invention may converge or spread the wire loops 140L by the rotation of the ball screw 111, which is the rotating body 110, while simultaneously adjusting the curvature radius of the wire loops 140L through the movement of the linear moving part 130. The variable wire gripper 100 may grip or release the object by surrounding the object with fine wires 140. In particular, as the loops 140L of the wires 140 form a hemispherical woven structure at the front of the tip 113, surrounding and gripping the object O, spherical objects that were difficult to grip in the related art may also be gripped. Additionally, the gripping and releasing of objects may be achieved even in narrow spaces.

In addition, the gripper system according to the present invention is configured such that the ball screw 111, which is the rotating body 110, and the toggle nut 131, which is the linear moving part 130, are engaged with each other. The gripper system may be selectively configured to operate by rotating the rotating body 110 or by moving the linear moving part 130. Therefore, various power sources may be selectively applied.

In this way, the variable wire gripper 100 and gripper system according to the present invention may reduce the payload by using the wires 140 made of a thin, soft, high tension material to grip and then transport an object while being lightweight.

### DESCRIPTION OF REFERENCE NUMERALS

100: Variable wire gripper
110: Rotating body
111: Ball screw
111S, 131S: Helical thread
113: Tip
115: Collar
117: Hole
120: Support body
121: Through hole
130: Linear moving part
131: Toggle nut
140: Wire
140L: Loop
150: Base plate
160: Nut plate
161: Guide bar
170: Motor
170L: Linear motor
O: Object

What is claimed is:

1. A variable wire gripper, comprising:
a plurality of wires, each having a loop formed by a curved middle portion and positioned forward, with one end fixed to a rotating body and the other end fixed to a linear moving part,
wherein the loops of the wires positioned forward converge on each other due to rotation of the rotating body and linear movement of the linear moving part, to surround and grip an object, or spread apart from each other to release the grip on the object.

2. The variable wire gripper of claim 1, wherein the rotating body and the linear moving part are engaged by a power source.

3. The variable wire gripper of claim 1, wherein the rotating body is a ball screw, the linear moving part is a toggle nut, and when the ball screw rotates due to a motor, which is a power source, the toggle nut mounted on the ball screw moves linearly along a length direction of the ball screw, or when the toggle nut is moved linearly by the motor, the ball screw rotates due to the movement of the toggle nut.

4. The variable wire gripper of claim 3, wherein a support body capable of rotating freely along a circumference is mounted around a tip of an end of the ball screw, and the wire forming a loop in front of the tip passes through the support body and extends to the linear moving part.

5. The variable wire gripper of claim 4, wherein a hole is formed at an edge of an end surface of the tip of the ball screw, into which one end of the wire is inserted and fixed, and the wire forming a loop in front of the tip passes through a through hole formed in the support body, extending linearly to the toggle nut, with the other end of the wire fixed to the toggle nut.

6. The variable wire gripper of claim 4, wherein a collar is formed on one of a circumference of the tip of the ball screw or an inner circumferential surface of the support body, and a groove is formed on the other to engage the collar, with the engagement of the collar and the groove allowing the support body to rotate freely around the circumference of the tip.

7. The variable wire gripper of claim 5, wherein the hole formed in the tip of the ball screw has an inclined structure, sloping from a center of the tip to the edge as the hole approaches the end surface of the tip.

8. The variable wire gripper of claim 7, wherein ends of the wires inserted into the hole are mutually bundled and fixed within the ball screw.

9. The variable wire gripper of claim 3, wherein the toggle nut is fixed to a nut plate, the nut plate has a plurality of guide bars fixed thereto, and the plurality of guide bars pass through the base plate to guide the linear movement of the toggle nut.

10. The variable wire gripper of claim 9, wherein the ball screw passes through the nut plate and is rotatably mounted on the base plate.

11. A variable wire gripper system, comprising:
a variable wire gripper having a plurality of wires, each having a loop formed by a curved middle portion and positioned forward, with one end fixed to a rotating body and the other end fixed to a linear moving part, and configured to surround and grip an object while the loops of the wires positioned forward converge on each other due to rotation of the rotating body and linear movement of the linear moving part, and release the grip on the object while spreading apart from each other; and
a motor connected to the rotating body to rotate the rotating body,
wherein the linear moving part is mounted on the rotating body and moves linearly in engagement with the rotation of the rotating body.

12. The variable wire gripper system of claim 11, wherein the linear moving part is mounted with a plurality of guide bars, and the plurality of guide bars pass through a base plate to guide the linear movement of the linear moving part, and the motor mounted on the base plate is connected to the rotating body mounted rotatably on the base plate to rotate the rotating body.

13. The variable wire gripper system of claim 12, wherein the rotating body is a ball screw, and the linear moving part is a toggle nut.

14. A variable wire gripper system, comprising:
a variable wire gripper having a plurality of wires, each having a loop formed by a curved middle portion and positioned forward, with one end fixed to a rotating body and the other end fixed to a linear moving part, and configured to surround and grip an object while the loops of the wires positioned forward converge on each other due to rotation of the rotating body and linear movement of the linear moving part, and release the grip on the object while spreading apart from each other;
a linear motor connected to the linear moving part to move the linear moving part in forward and backward directions,
wherein the linear moving part is mounted on the rotating body, and the rotating body rotates in engagement with the movement of the linear moving part.

15. The variable wire gripper system of claim 14, wherein the linear moving part is mounted with a plurality of guide bars, and the plurality of guide bars pass through a base plate to guide the linear movement of the linear moving part, and the linear motor mounted on the base plate is connected to the guide bars to move the guide bars in forward and backward directions.

16. The variable wire gripper system of claim 15, wherein the rotating body is a ball screw, and the linear moving part is a toggle nut.
